(19) United States
(12) Patent Application Publication
(10) Pub. No.: US 2008/0218812 A1
(43) Pub. Date: Sep. 11, 2008

(54) Metadata image processing

(76) Inventor: John P. Wolf, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/714,355

(22) Filed: Mar. 5, 2007

(51) Int. Cl. H04N 1/04

(52) U.S. Cl. 358/474; 358/1.1; 358/400

(57) ABSTRACT

Embodiments including using metadata for image processing are disclosed.

Various proprietary systems allowing for downstream processing of information content of a hardcopy document are commercially available. However, such systems often can involve entering the information into designated portions of a form that is constructed to be consistent with programmed coordinates for particular types of information in an information processing system. Such a system may be limited to processing the particular types of information asked for on the form, processing the format of the particular form, and/or directing the information content of the form to specified types of downstream processing.

As such, the forms, information provided thereon, and downstream workflow enabled thereby may be incompatible between the available document processing systems. In addition, utilizing such a system along with an available image processing apparatus can result in partially overlapping capabilities possessed by both that are not necessary and/or not cost-effective.

### BRIEF DESCRIPTION OF THE DRAWINGS

FIG. 1A illustrates an example image processing apparatus suitable to process source image data according to embodiments of the present disclosure.

FIG. 1B illustrates creating metadata according to embodiments of the present disclosure.

FIG. 1C illustrates tagging metadata to be included as output according to embodiments of the present disclosure.

FIG. 2 illustrates a routing environment according to embodiments of the present disclosure.

FIG. 3A illustrates an embodiment of an apparatus that is operable to implement or that can include embodiments of the present disclosure.

FIG. 3B illustrates a block diagram embodiment of one or more components includable in an apparatus, such as the apparatus shown in FIG. 3A.

FIG. 4 is a block diagram illustrating a method of using an indicator for metadata according to an embodiment of the present disclosure.

### DETAILED DESCRIPTION

In various embodiments of the present disclosure, image scanning apparatuses can include functionalities for processing an image (e.g., a document) using executable instructions for recognizing alphanumeric text (e.g., optical character recognition using an OCR functionality), tagging a scanned document with supplemental text data extracted from the original scanned image (e.g., using the OCR functionality), and processing content of the scanned image for downstream workflow based on particular information (e.g., a number of indicators) in the scanned image (e.g., metadata image processing). A metadata item can be a name/value pair (e.g., an indicator, as described below) used to provide supplemental information regarding the content of the document with which it is associated or to which it is tagged. A document can have an unlimited amount of associated metadata. Metadata can highlight data sourced, or not sourced, from within the document itself.

An image scanning apparatus can use OCR functionality during scanning of a hardcopy document (e.g., a random business form) to save a copy of an image of the hardcopy document. The OCR functionality can, in combination with appropriate computer-executable instructions (e.g., a metadata engine), analyze a scanned image to determine various types of information content in the scanned image. The OCR functionality also can, in combination with appropriate computer-executable instructions (e.g., the metadata engine), analyze and use the particular information (e.g., the number of indicators) in the scanned image to determine location coordinates for the various types of information content in the scanned image.

Prior to scanning the hardcopy document (e.g., an original document or a copy of the original), a number of differentiable indicators can be provided thereon that contain information related to location of areas in the document having recognizable text content usable in downstream workflow (e.g., metadata image processing). Based on analysis (e.g., by the metadata engine) of the information content of the number of indicators in the scanned image, computer-executable instructions can find locations of the recognizable text content using coordinates contained in the information content of the number of indicators. In various embodiments, a differentiable name can be included in the information of the number of indicators in combination with coordinates for the information contained in the scanned image of the document to provide information regarding the content of the location. In some embodiments, a name can include a descriptor for an associated heading, category, or tagline for a general type of information combined with a descriptor for specific content. A number of indicators containing such information can be provided on (e.g., attached to) the hardcopy document and become part of the scanned image. The number of indicators being part of the scanned image can enable using content of scanned image for self-directed processing of content of the scanned image as metadata for downstream workflow.

For instance, in some embodiments, a computer-assisted search for information related to a name contained in the number of indicators of a scanned image can be conducted. Finding a particular indicator in the scanned image can enable using the location coordinates contained in the indicator to self-direct contents of the scanned image to downstream workflow (i.e., processing). In some embodiments, finding the number of indicators can enable using the location coordinates for collecting and associating the located metadata for use in routing of the scanned image content, where routing can allow post-scan processing, storage, and/or sending.

In various embodiments, an indicator can allow finding information in a scanned image to be independent of the format of the original hardcopy by using dimensions of the scanned image in any suitable coordinate system as underlying coordinates for locating a section containing relevant information. For example, a location for an area of a scanned image can be documented in an indicator using a dimensionless proportionality quotient obtained when a magnitude of a part is divided by a magnitude of another part the scanned image. As utilized in the present disclosure, a percentage(s) relative to an axial distance of the scanned image (e.g., width and/or height of a particular page of the scanned image) can represent, by way of example and not by way of limitation, the dimensionless proportionality quotient used in the indicator for locating the section containing the relevant information.

Areas containing related information in a scanned image of a document can be assigned a single indicator containing coordinates for each related section. Areas of a scanned image of a document (e.g., separate pages, differing types of information, such as alphanumeric text, graphic images, and symbols, among others) can, in some embodiments, be each assigned an indicator with a differentiable name in combination with the location coordinate(s) to form a name/value pair. At least a portion of a name in the name/value pair can be contained in content of the area defined by the coordinates. As such, an indicator can enable self-directed downstream workflow of content of a scanned image based upon information found in the name and coordinates (i.e., the name/value pair) of the indicator.

Accordingly, among various embodiments of the present disclosure, information obtained from analysis of a scanned image by an optical character recognition (OCR) functionality can be used to identify at least one indicator. Information in the at least one indicator on a particular page of the scanned image can be used to locate content recognized as text to serve as metadata, where the information is expressed using a percentage relative to a particular parameter of the particular page of the scanned image. Identifying at least one indicator can, in some embodiments, include identifying an indicator that enables locating metadata in a self-directed manner on a per page basis for downstream processing of the metadata. In some embodiments, the at least one indicator can be provided on a hardcopy document prior to scanning the hardcopy document to create the scanned image.

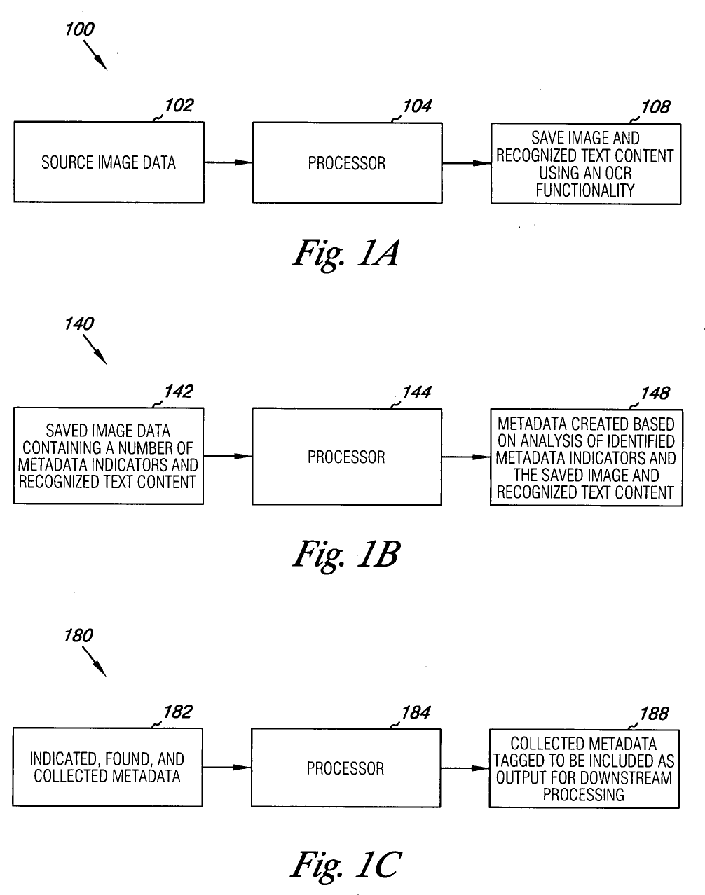

FIG. 1A illustrates an example image processing apparatus suitable to process source image data according to embodiments of the present disclosure. FIG. 1A illustrates an image processing apparatus 100. The image processing apparatus 100 can include receiving source image data 102, a processor 104, and image and/or recognized text content saved using an OCR functionality 108. In some embodiments, the image and/or recognized text content of the source image data 102 can be saved using other functionalities of an imaging apparatus having an OCR functionality operatively associated with the processor 104. In some embodiments, processing of a scanned image for downstream workflow can be performed without saving a copy of the scanned image in long-term memory. For example, metadata contents of a scanned image can be sent downstream for post-scan processing, at which point the content can be saved in long-term memory.

The processing apparatus 104 of FIG. 1 can have a memory coupled thereto, where program instructions can be stored for execution by the processor 104. In various embodiments, the program instructions executed to receive the source image data 102 can include instructions to execute receiving and processing source image data associated with pixels in alphanumeric character text (e.g., recognized text content), graphic image, symbols, and mixed text, image, and/or symbol documents.

In addition, program instructions can be executed to receive source image data from various sources. The instructions can be executed to receive source image data from a number of apparatus types (e.g., a telecommunication apparatus, a telefaxing apparatus, a computing apparatus, a copying apparatus, and/or a scanning apparatus, among others) that can be connected to the image processing apparatus 100. For example, all of the functionalities disclosed in the present disclosure can be included in an All-In-One (AIO) system having an associated (e.g., embedded) image processing apparatus 100 that can contribute to performing the functions described below.

FIG. 1B illustrates creating metadata according to embodiments of the present disclosure. FIG. 1B illustrates an image processing apparatus 140 that can process saved image data containing a number of metadata indicators and recognized text content 142. Embodiments of the present disclosure can use program instructions executable by a processor 144 (e.g., a metadata engine) to create metadata and/or a collection and association of metadata based on analysis of the number of identified metadata indicators and the saved image and recognized text content 142, as described below. Analysis of the identified metadata indicator and the saved image and recognized text 142 can be performed using a metadata engine to execute computer-readable instructions functioning as the processor 144 or in combination with the processor 144.

In various embodiments, the metadata using information in the saved image and recognized text content can be created based on analysis of the identified metadata indicators 148. The indicators can, in some embodiments, be identified using information obtained from analysis by the metadata engine. The analysis can be used for differentiating a name forming a part of an indicator from other recognized test content in the saved image. In some embodiments, a name used in an indicator can include information derived from and/or appearing in a title and/or a text contained in at least one area of the scanned image. By way of example and not by way of limitation, a differentiable name for the indicator can contain a combination of portions of “Employment Application” from the title of an application form and portions of the name of the person (e.g., John Smith) contained in the text of the saved image. For example, the indicator as provided on the document to be scanned, recognized in the scanned image, and processed by the processor 144 can include “EmpAppJohnSmith” as at least part on the name. In some embodiments, as described below, the apparatus can provide at least a part of the name as a tag included in the saved image to denote at least one area as information to be used as metadata.

The information in an indicator and identified through analysis of content of the saved image (e.g., using the metadata engine) can include at least one coordinate to denote a location of content in the saved image to be used as metadata. The at least one coordinate can, in some embodiments, be used to form a second part of the indicator. The indicator can have a series of axial coordinates for at least one location of a bounding rectangular area of the scanned image. In some embodiments, the axial coordinates can use a percentage relative to a particular parameter such that a section of a particular page is defined by using a bounding rectangle with at least two corners assigned an x coordinate relating to a page width and a y coordinate relating to a page height.

The bounding rectangle with corners assigned an x coordinate relating to the page width and a y coordinate relating to the page height can be made independent of a page size and a resolution of the original hardcopy document and/or a scanned image. In various embodiments, independence from page size and/or resolution can be executed by using: a percentage of a distance from a left-hand edge and a right-hand edge of the image page as a top left corner x coordinate width offset; a percentage of the distance from the left-hand and the right-hand edge of the image page as a width; a percentage of a distance from an upper edge and a lower edge of the image page as a y coordinate length offset; and a percentage of the distance from the upper edge and the lower edge of the page as a length.

FIG. 1C illustrates tagging metadata to be included as output according to embodiments of the present disclosure. FIG. 1C illustrates an image processing apparatus 180 that can process previously indicated, found, and collected metadata 182, as shown in 148 of FIG. 1B. Some embodiments of the present disclosure can use program instructions executable by a processor 184 to provide at least one metadata item or tag to collected metadata to be included as output for downstream processing 188. As such, tagging the collected metadata can be used for identifying extracted and collected metadata for integration with data output (e.g., from an image scanning apparatus) to be transferred to a destination (e.g., externally for downstream processing).

Programmable and computer-readable instructions illustrated as being executable by the processor 104 of FIG. 1A, the processor 144 of FIG. 1B, and the processor 184 of FIG. 1C can be performed using any number of processors (e.g., executed by the same processor) in an imaging system. In addition, the one or more processors can be positioned in any apparatus of the imaging system.

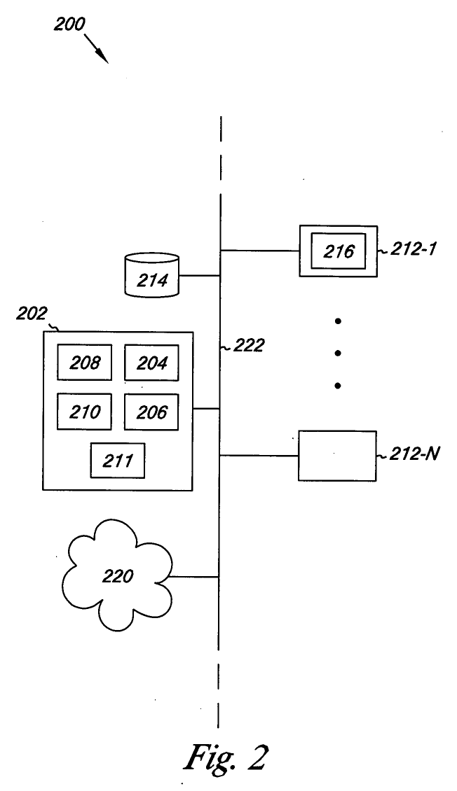

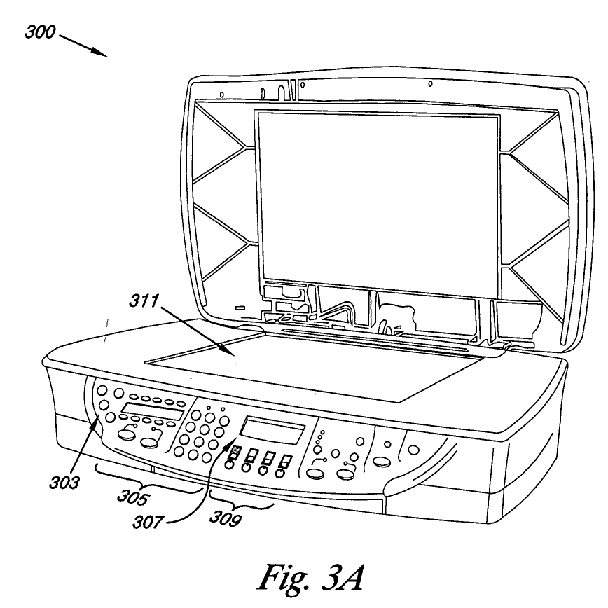

FIG. 2 illustrates a routing environment according to embodiments of the present disclosure. FIG. 2 illustrates a routing environment system 200 that can include an image scanning apparatus 202. In various embodiments, including the embodiment shown in FIG. 2, the image scanning apparatus 202 can include one or more processors and/or application modules 204, one or more memory devices 206, an OCR functionality 210, and a metadata engine 211. The one or more processors and/or application modules 204 are operable on computer readable instructions for processing information and data as the same will be known and understood by one of ordinary skill in the art. In various embodiments, the one or more processors and/or application modules 204, in combination with the OCR functionality 210 and/or the metadata engine 211, are operable on computer readable instructions for receiving, analyzing, creating metadata, providing at least one tag for metadata, and/or saving content of source image data, as illustrated in FIGS. 1A-C.

In the various embodiments, the one or more memory devices 206 include memory devices 206 on which computer readable instructions, data, and other information can be stored, temporarily or otherwise. In various embodiments, the one or more memory devices 206 can include fixed memory, such as a hard drive, a memory chip on a printed circuit board, and the like. By way of example and not by way of limitation, the one or more memory devices 206 can include memory devices 206 such as Non-Volatile (NV) memory (e.g., Flash memory), RAM, ROM, DDRAM, magnetic media, optically read media, and the like.

As shown in the embodiment of FIG. 2, the image scanning apparatus 202 can include an image scanning apparatus driver 208. In various embodiments of FIG. 2, additional image scanning apparatus drivers 216 can be located off the image scanning apparatus 102 such as, for example, on a remote device (e.g., remote device 212-1 in FIG. 2). Such additional image scanning apparatus drivers can be an alternative to the image scanning apparatus driver 208 located on the image scanning apparatus 202 or provided in addition to the image scanning apparatus driver 208.

As will be appreciated by one of ordinary skill in the relevant art, an image scanning apparatus driver 208 is operable to create a computer readable instruction set for processing content of an image received and analyzed by the one or more processors and/or application modules 204, in combination with the OCR functionality 210 and/or the metadata engine 211. As such, the image scanning apparatus driver can be operable on computer readable instructions for receiving, analyzing, creating metadata, providing at least one tag for metadata, and/or saving content of source image data, as illustrated in FIGS. 1A-C, and routing saved image content as self-directed by the attached indicator(s), as described below. Image scanning apparatus driver 208 can include any image scanning apparatus driver suitable for carrying out various aspects of the present disclosure. That is, the image scanning apparatus driver 208 can receive and execute instructions from one or more software applications and utilize such instructions in processing and routing of saved image contents.

In various embodiments, metadata engine 211 (e.g., embedded in an image scanning apparatus) can be utilized to search and analyze content of an image (e.g., a saved image originating from source image data of a scanned document). Text content recognized by an OCR functionality 210 in a scanned image can be searched in a scanned image page for alphanumeric text data formatted using various image fonts (e.g., MICR CMC7, MICR E13b, OCRa, and OCRb, among others) that also are readable by a user, or as a sequence encoded using a barcode symbology, as presented on an original document. Indicators formatted in such fonts and/or encoded in such barcode symbologies can be found and recognized by the OCR functionality in the scanned image.

Operating in combination with a processor and executable instructions, the metadata engine 211 can be used to search a saved image for information usable in creating metadata. Also operating in combination with a processor and executable instructions, the metadata engine 211 can be used to define areas in a saved image within which information is contained (e.g., in the various image fonts described above).

For example, the metadata engine 211 can analyze an image and areas containing recognized alphanumeric text can be defined in a page size and image resolution independent manner (e.g., using percentage(s) of the image width and/or length) as being contained in a geometrically defined shape (e.g., a bounding rectangle). The defined areas can be used in creating metadata to enable sending such metadata for downstream workflow. The bounding rectangle, for example, determined using the metadata engine 211 can have defining coordinates included in a tag for metadata created for and provided in the saved image. In various embodiments, when a bounding rectangle is determined by the OCR functionality 210 and/or the metadata engine 211 to contain a graphic image and/or symbols, whether or not alphanumeric text is also included, a bounded image graphic can be captured (e.g., converted to base64 character encoding) and assigned a differentiable tag name.

Operating in combination with a processor and executable instructions, the metadata engine 211 can, in some embodiments, identify an indicator (e.g., for each page of a saved image) having a combination of a differentiable name and defining coordinates for content in the saved image. The indicator created as such can be provided on a document prior to scanning and be included in the saved image to allow searchable detection of the metadata (and the saved image) based upon the unique name, which also can enable self-directed downstream processing of the contents based upon the coordinates contained in the indicator. The metadata engine 211 can execute programmable instructions to search each saved image page in a predefined location, for example, to detect an indicator containing information regarding metadata on the page.

In various embodiments, the indicator can include only coordinates defining areas usable as metadata. In some embodiments, programmable instructions can be executed to use the defining coordinates and extract information therefrom to be used in at least one metadata tag provided in the saved image. The at least one tag for metadata can be provided in (e.g., attached to) a saved image by executing programmable instructions, for example, adjacent a metadata location on each page of the saved image.

As shown in the embodiment of FIG. 2, image scanning apparatus 202 can be networked to one or more remote devices 212-1, . . . , 212-N over a number of data links, shown as 222. The number of data links 222 can include one or more physical connections, one or more wireless connections, and any combination thereof, as part of a network for downstream processing workflow on saved image contents. That is, the image scanning apparatus 202 and the one or more remote devices 212-1, . . . , 212-N can be directly connected and/or can be connected as part of a wider network having a plurality of data links 222. Any number of remote devices and remote device types 212-1, . . . , 212-N can be networked to the image scanning apparatus 202.

In various embodiments, the one or more remote devices 212-1, . . . 212-N illustrated in FIG. 2 can include remote devices such as one or more desktop computers, laptop computers, or workstations, among other device types. In some instances, one or more remote devices 212-1, . . . , 212-N can include one or more peripheral devices distributed within the network. By way of example and not by way of limitation, peripheral devices can include other scanning devices, fax capable devices, copying devices, and the like. As noted above, in various embodiments, an image scanning apparatus 102 can include a multi-function device (e.g., an AIO apparatus) having several functionalities such as printing, copying, and scanning included. As will be appreciated by one of ordinary skill in the relevant art, such remote devices 212-1, . . . , 212-N can also include one or more processors and/or application modules suitable for running software and can include one or more memory devices thereon. In various embodiments, the one or more remote devices 212-1, . . . , 212-N can include a remote device such as a wireless phone, a personal digital assistant (PDA), or other handheld device.

As illustrated in the embodiment shown in FIG. 2, a routing environment system 200 can include one or more networked storage devices 214 (e.g., remote storage databases, and the like). Likewise, the routing environment system 200 can include one or more Internet connections 220. As one of ordinary skill in the relevant art will appreciate, the network described herein can include any number of network types including, but not limited to, a Local Area Network (LAN), a Wide Area Network (WAN), a Personal Area Network (PAN), and the like. And, as stated above, data links 222 within such networks can include any combination of direct or indirect wired and/or wireless connections, including but not limited to, electrical, optical, and RF connections.

As further appreciated by one of ordinary skill in the relevant art, memory, such as memory 206 and memory 214, can be distributed anywhere throughout a networked routing system. Memory, as the same is used herein, can include any suitable memory for implementing the various embodiments of the disclosure. Thus, memory and memory devices can include fixed memory and portable memory. Examples of portable memory can include memory cards, memory sticks, flash cards, and the like. Other memory mediums can include CDs, DVDs, and floppy disks. The invention, however, is not limited to any particular type of memory medium and is not limited to where within a device or networked system a set of executable instructions reside for use in implementing the various embodiments of the disclosure. One of ordinary skill in the art will appreciate the manner in which software (e.g., computer-readable and computer-executable instructions) can be stored on a memory medium.

An image scanning apparatus, such as the image scanning apparatus 202 shown in the routing environment 200 illustrated in FIG. 2, can be used with a processor, a memory coupled to the processor, and program instructions storable in the memory. The programmable instructions can be executable by the one or more processors to enable downstream workflow by saving image content of received source image data with an OCR functionality, identifying at least one indicator in a saved image based on analysis of content of the saved image, and using the at least one indicator for locating various metadata on a per image page basis. In some embodiments, programmable instructions can be executable by the one or more processors to create metadata for a saved image content based on analysis of content in the saved image by a metadata engine, and/or providing a tag for metadata in the saved image. In various embodiments, the downstream workflow can be selected from among workflow types that automatically comply with instructions related to naming standards (e.g., sending a saved image to a particular storage file and/or memory device determined by defined naming parameters), respond to a user request for the content, and/or allow further processing of the content.

The routing environment 200 illustrated in FIG. 2 can, in various embodiments, be used with instructions executable to identify and link the at least one indicator with content in the saved image and to route content in the saved image serving as metadata, the location of which is identified by the indicator, for downstream workflow processing. In various embodiments, the downstream workflow processing can be selected from among workflow types that allow a review of the content (e.g., automatically and/or by user examination of the content), allow approval of the content based on applicable standards, allow a personnel-related action based on the content, allow sending a hardcopy of the content (e.g., after printing a copy of the saved image), allow sending an electronic copy of the content (e.g., using the Internet), and enable downstream storage of the content (e.g., in various designated file locations and/or memory devices).

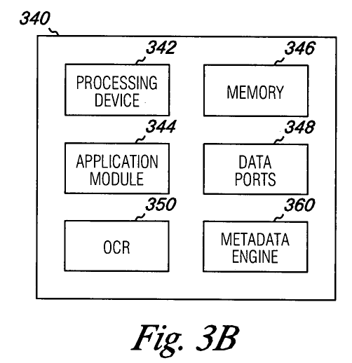

FIGS. 3A and 3B illustrate embodiments of apparatuses that are operable to implement or that can include embodiments of the present disclosure. As one of ordinary skill in the relevant art will appreciate, embodiments of the present disclosure are not limited to inclusion with or implementation on those apparatuses illustrated in FIGS. 3A and 3B.

FIG. 3A illustrates an embodiment of an apparatus that is operable to implement or that can include embodiments of the present disclosure. FIG. 3A illustrates an image scanning apparatus 300 according to an embodiment of the present disclosure. The embodiment of FIG. 3A illustrates an image scanning apparatus 300 that can, in various embodiments, be connected to a number of remote devices to form an image scanning system contributing to a routing environment, as shown in embodiment 200 of FIG. 2. Remote devices can include, for example, computing devices such as one or more desktop computers, laptop computers, and/or workstations, among other types of devices.

In some embodiments, the image scanning apparatus 300 can be included as part of, or connected to form, a multi-functional system including more than one function mode, such as scanning, copying, faxing, and/or printing (e.g., an AIO apparatus). Such a system can include, in various locations within image scanning apparatus 300, one or more processors and/or application modules suitable for executing software programming (e.g., executable instructions) and can include, in various locations, one or more memory devices. The image scanning system that includes the image scanning apparatus 300 can include one or more of the embodiments described herein.

The embodiment of FIG. 3A illustrates an image scanning apparatus 300 that includes one or more control keys 303 that can control on/off status, sleep status, and/or function mode, among other activities. The image scanning apparatus 300 can include one or more display screens with a number of associated user input interfaces 305 that can be used, for example, in assigning a differentiable name to be used for an indicator provided in a saved image of a document being scanned and/or entering search parameters for a differentiable name in an indicator usable for finding a saved image and/or contents thereof.

The image scanning apparatus 300 also can include one or more scan mode display screens 307. In some embodiments, the display screens can display information using LCD graphics, among other display types. Scan mode selectors 309 can be used for control of the scan operation and/or OCR functionalities and metadata engines, as described below.

The embodiment of the image scanning apparatus 300 illustrated in FIG. 3A includes a scan window 311 that can, in various embodiments, be formed from any suitable wavelength transparent, semi-transparent, or translucent material that allows throughput of illuminating and/or reflected light. The scan window 311 can have various geometric formats of various sizes (e.g., squares, rectangles, circles, ovals, trapezoids, etc.) to accommodate particular objects to be associated therewith and scanned therethrough. Although the scan window 311 is referred to in the singular, some embodiments can have more than one scan window to enable use of various configurations of routing environments having more than one image scanning apparatus. Various embodiments of the image scanning apparatus 300 illustrated in FIG. 3A can perform the function of scanning an object to provide an image using a combination of components that include a number of mirrors, lenses, filters, lamps, light-emitting diodes (LEDs), and/or photosensitive elements, for example, charge coupled devices (CCD), contact image sensors (CIS), etc., among other components.

As shown in the embodiment of FIG. 3A, the image scanning apparatus 300 can include one or more data input mechanisms. The one or more data input mechanisms can include one or more input interfaces 305, such as on a control panel, one or more media slots (not shown) operable to receive one or more removable memory, such as a flash memory card, and one or more data ports (not shown) operable to receive additional data input (e.g., source image data, and transferred saved image content, among others).

As one of ordinary skill in the relevant art will appreciate, the one or more data ports can include a data port operable to receive parallel or serial data connection. For example, the one or more data ports can include a data port configured to receive a high speed serial cable connection, such as a USB cable. The one or more data ports can further include a data port configured to receive data in a wireless fashion, such as by using an IR or Bluetooth wireless mechanism. The image scanning apparatus 300 embodiment of FIG. 3A thus can be operable to obtain data of any type, from any number of sources. Data in the various embodiments can include information such as user commands, source image data, saved image content, and computer readable instructions or instruction sets, among others.

FIG. 3B illustrates a block diagram embodiment of one or more components includable in an apparatus, such as the apparatus shown in FIG. 3B. The embodiment of FIG. 3B illustrates the apparatus 340 including one or more processing devices 342 and one or more application modules 344 suitable for operating on software and computer executable instructions. In the embodiment of FIG. 3B, the apparatus 340 is further illustrated as having one or more resident memory mediums 346 and one or more removable or portable memory mediums and/or data ports 348 as the same have been described herein. By way of example and not by way of limitation, the one or more portable memory mediums can include selectably insertable memory mediums, such as memory cards.

The embodiment shown in FIG. 3B also can include one or more OCR functionalities 350. The OCR functionality 350 can provide information about, but not limited to, alphanumeric characters, graphic images, and/or symbols present in a scanned and/or saved image, density and size of image contents, and a number of pages saved in an image, among others. In the various embodiments utilizing one or more OCR functionalities 350, the information provided by the OCR functionality 350 can facilitate several other functions. For example, when at least one indicator is provided at a predetermined location on a page of a hardcopy document, the OCR functionality 350 can properly orient the page of the hardcopy document and, consequently, a scanned image resulting from scanning of the hardcopy document. Such proper orientation can facilitate identification of indicator(s) by a metadata engine 360.

Among the various embodiments of the metadata engine 360 consistent with the present disclosure, as illustrated in the embodiment of FIG. 3B showing the apparatus 340 to have the metadata engine 360 operating in combination with one or more processing devices 342 and one or more application modules 344, programmable instructions can be executed to identify an indicator in a saved image. In various embodiments, such instructions can be executable to identify a number of indicators created and provided using an alphanumeric metadata and/or a bar code.

As described above, the instructions can be executed to identify an indicator including a differentiable alphanumeric name for the saved image. In some embodiments, a differentiable name used in the indicator and/or a tag for metadata in the image can include information derived from analysis of content of the saved image by the OCR functionality 350 operating in concert with the metadata engine 360. In various embodiments, the instructions can be executed to identify an indicator that includes in the indicator at least one coordinate to define at least one location of content of the saved image. As such, the instructions can be executed to identify an indicator including both the differentiable alphanumeric name and the at least one coordinate defining the at least one location of content of the saved image.

The instructions for the metadata engine 360 operating in combination with a processing device 342 can be executed, in various embodiments, to identify the at least one indicator based upon a differentiable presentation of information in the indicator. For example, differentiable types of information presentations can include an alphanumeric character sequence, a font type and size, and a bar code, each of which can be differentiated from typical text information in a document. As such, the instructions executable to identify the at least one indicator based upon a differentiable presentation can be executable to differentiate the presentation of the at least one indicator from other content in an image page. Hence, the instructions executable to identify the at least one indicator are executable using a metadata engine 360 to identify the at least one indicator by analysis of content of the image saved by the OCR functionality.

In some embodiments, the metadata engine 360 can execute instructions to use at least one coordinate derived from analysis of the at least one indicator to define at least one location of content in the saved image. The metadata engine 360 can, in some embodiments, execute instructions to provide at least one tag in the saved image to further define the at least one location of content serving as metadata. A differentiable name used in a tag for metadata in a saved image of a scanned document can be derived from metadata engine 360 analysis of the title and/or text of the scanned document, such that the differentiable name assigned to the metadata tag includes elements of the analyzed document title and/or an analyzed text string.

In some embodiments, the metadata engine 360 can execute instructions to identify and use at least one indicator having a differentiable alphanumeric name in a name/value pair with at least one coordinate defining content in at least one location, where at least a portion of a name in the name/value pair is contained in content of the at least one location. The metadata engine 360 can, in some embodiments, execute instructions to identify the at least one indicator by using at least two different delimiter characters that differentiate at least two of the differentiable alphanumeric name, the at least one coordinate defining at least one location of content, and/or a termination of the indicator.

By way of example and not by way of limitation, a first delimiter differentially denoting the differentiable name can, for example, utilize an uncommonly used alphanumeric character and/or punctuation mark in association with the differentiable name. For instance, the differentiable name of an indicator can be denoted using an equal sign (=) delimiter in front of the differentiable name. Accordingly, the differentiable name described above can be denoted in an indicator as: =EmpAppJohnSmith.

By way of further example and not by way of limitation, location of content in the saved image can be described in the indicator with regard to percentage(s) of page width and/or height using axial parameters in the (x,y) coordinate system. For example, as described above, a bounding rectangle with corners assigned an x coordinate relating to the page width and a y coordinate relating to the page height can be used to define location of an area in the indicator. In some embodiments, the location of the bounding rectangle can be defined with four numbers by using: a percentage of a distance from a left-hand edge and a right-hand edge of the image page as a top left corner x coordinate width offset; a percentage of a distance from an upper edge and a lower edge of the image page as a y coordinate length offset; a percentage of the distance from the left-hand and the right-hand edge of the image page as a width; and a percentage of the distance from the upper edge and the lower edge of the page as a length.

Numbers used to define the location of an area containing relevant information in the indicator in a saved image can be denoted using a second delimiter different from the delimiter used to denote the differentiable name in the indicator. For example, a number of colons (:) can be used in front of and/or between numbers representing percentages in the indicator. For instance, the sequence: 50:50:10:10 can be used to designate a rectangular bounded region with the first number indicating a width offset component of a top left corner as being 50% of the distance from a left-hand edge and a right-hand edge of the image page. In such as sequence, a length offset component can be represented by the second number as being 50% of the distance from an upper edge and a lower edge of the image page. In the sequence shown, the third number can represent the width of the bounded region as being 10% of the distance from the left-hand and the right-hand edge of the image page and the fourth number can represent the length of the bounded region as being 10% of the distance from the upper edge and the lower edge of the page.

The coordinates just described represent with four numbers the offsets and side lengths of a rectangle bounding an area containing information to be described in the indicator. In some embodiments, executable instructions can be programmed to identify each four number sequence having numbers separated with a colon delimiter from the preceding differentiable name and/or the preceding number as representing a rectangular boundary for information relevant to the differentiable name of the indicator. Hence, a sequence in an indicator such as, for example, :50:50:10:10:20:70:10:10 can be identified by executable instructions as describing two rectangular bounded regions that are each represented by four percentages.

In various embodiments, a third delimiter can be used to denote a termination of the indicator. An alphanumeric character and/or punctuation mark different from those used as the first and second delimiters can be used to indicate termination of the indicator. For example, a semicolon (;) can be used in some embodiments to indicate termination of the indicator.

A number of coordinates defining a number of rectangular regions can be included in the indicator. Including coordinates for many rectangular regions in the indicator can result in a lengthy sequence of alphanumeric characters. To facilitate the indicator being provided in (e.g., attached to), and fitting on one line of, a saved image, instructions can be executed to attach the indicator using a smaller font than used in the remainder of the saved image. For example, in some embodiments, the indicator can use an 8 point font and the information in the rectangular regions described in the indicator can use 12 point font as a mechanism of distinguishing the indicator for facilitating identification of the indicator by the metadata engine 360.

An example of an indicator embodiment using the three delimiter embodiments just described and using 8 point font can be represented as:
=EmpAppJohnSmith:50:50:10:10:61:76:10:10:84:32:12:20:90:90:10:10;

Various embodiments of the present disclosure can be performed by software, application modules, computer executable instructions, and/or application-specific integrated circuits (ASIC) operable on the systems, apparatuses, and devices described above, or otherwise, for eventuating the functionalities of the present disclosure. As one of ordinary skill in the relevant art will appreciate upon reading and practicing the disclosure, software, application modules, computer executable instructions, and/or ASICs suitable for eventuating the functionalities of the present disclosure can be resident in a single apparatus (e.g., an image scanning apparatus 300 as illustrated in FIG. 3A) or the same can be resident in more than one apparatus across several and even many locations, such as in a distributed routing environment (e.g., a routing environment 200 as illustrated in FIG. 2). The present disclosure is not limited either to any particular operating environment or to software written in a particular programming language.

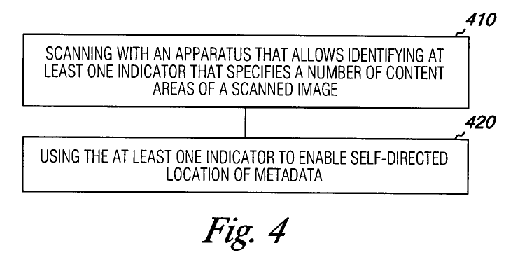

FIG. 4 is a block diagram illustrating a method of using an indicator for metadata according to an embodiment of the present disclosure. Unless explicitly stated, the method embodiments described herein are not constrained to a particular order or sequence. Additionally, some of the described method embodiments, or elements thereof, can occur or be performed at the same, or at least substantially the same, point in time.

The embodiment illustrated in FIG. 4 includes scanning with an apparatus that allows identifying at least one indicator that specifies a number of content areas of a scanned image, as shown in block 410 and as described above. Block 420 of the embodiment shown in FIG. 4 includes using the at least one indicator to enable self-directed location of metadata. That is, the at least one indicator in the scanned image can include coordinates specifying at least one location of information to be used as metadata. The self-directed location of metadata can, in various embodiments, enable self-directed routing of the metadata in the scanned image content, where such routing can include routing for post-scan processing, storage, and sending. The self-directed routing can be used for post-scan downstream workflow, as described above and below.

In some embodiments, an image scanning apparatus, as illustrated in FIG. 3A, and/or a routing environment, as illustrated in FIG. 2, can use computer-readable instructions (e.g., to automatically comply with instructions related to naming standards, to respond to a user request for the content, among others) to execute a search for information located in the indicator on a page of the scanned image to enable self-directed routing of metadata in the scanned image content. In some embodiments, computer-readable instructions can be used to execute a search in an index of indicators for information to enable accessing and routing of the scanned image content.

Although specific embodiments have been illustrated and described herein, those of ordinary skill in the relevant art will appreciate that an arrangement calculated to achieve the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein, will be apparent to those of ordinary skill in the relevant art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure need to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of image processing, comprising:
using information obtained from analysis of a scanned image by an optical character recognition (OCR) functionality to identify at least one indicator;
using information in the at least one indicator on a particular page of the scanned image to locate content recognized as text to serve as metadata; and
wherein the information is expressed using a percentage relative to a particular parameter of the particular page of the scanned image.

2. The method of claim 1, wherein identifying at least one indicator includes identifying an indicator that enables locating metadata in a self-directed manner on a per page basis for downstream processing of the metadata.

3. The method of claim 1, wherein the method includes providing the at least one indicator on a hardcopy document prior to scanning the hardcopy document to create the scanned image.

4. The method of claim 1, wherein using a percentage relative to a particular parameter includes using axial coordinates such that a section of the particular page is defined by using a bounding rectangle with at least two corners assigned an x coordinate relating to a page width and a y coordinate relating to a page height.

5. The method of claim 4, wherein using the bounding rectangle with corners assigned an x coordinate relating to the page width and a y coordinate relating to the page height is made independent of a page size and a resolution by using:
a percentage of a distance from a left-hand edge and a right-hand edge of the image page as a top left corner x coordinate width offset;
a percentage of the distance from the left-hand and the right-hand edge of the image page as a width;
a percentage of a distance from an upper edge and a lower edge of the image page as a y coordinate length offset; and
a percentage of the distance from the upper edge and the lower edge of the page as a length.

6. A computer-usable medium having computer-readable instructions stored thereon for executing a method comprising:
scanning with an apparatus that allows identifying at least one indicator that specifies a number of content areas of a scanned image; and
using the at least one indicator to enable self-directed location of metadata.

7. The medium of claim 6, wherein the method includes collecting and associating the located metadata for use in routing of the scanned image content, wherein routing includes routing for post-scan processing, storage, and sending.

8. The medium of claim 6, wherein the method includes providing the at least one indicator at a predetermined location on a page of the hardcopy document, wherein optical character recognition (OCR) properly orients the page of the hardcopy document.

9. The medium of claim 8, wherein the method includes using computer-readable instructions to execute a search for information located in the indicator on the page of the scanned image to enable self-directed routing of metadata in the scanned image content.

10. The medium of claim 8, wherein the method includes using computer-readable instructions to execute a search in an index of indicators for information to enable accessing and routing of the scanned image content.

11. An imaging apparatus, comprising:
a processor;
a memory coupled to the processor; and
program instructions storable in the memory and executable by the processor to:
save image content of received source image data with an optical character recognition (OCR) functionality;
identify at least one indicator in a saved image based on analysis of content of the saved image; and
use the at least one indicator for locating various metadata on a per image page basis to enable downstream workflow selected among workflow to:
automatically comply with instructions related to naming standards;
respond to a user request for the content; and
allow further processing of the content.

12. The imaging apparatus of claim 11, wherein the instructions executable to identify the at least one indicator include instructions executable to link the indicator with content in the saved image serving as metadata and to route the metadata for downstream workflow selected among workflow to:
allow a review of the content;
allow approval of the content based on applicable standards;
allow a personnel-related action based on the content;
allow sending a hardcopy of the content;
allow sending an electronic copy of the content; and
enable downstream storage of the content.

13. The imaging apparatus of claim 11, wherein the instructions executable to identify the at least one indicator in the saved image are executable to identify the at least one indicator using characters selected from a group including alphanumeric characters and bar code.

14. The imaging apparatus of claim 11, wherein the instructions executable to identify the at least one indicator are executable to identify the at least one indicator based upon a differentiable presentation selected from a group including:
an alphanumeric character sequence;
a font type and size; and
bar code.

15. The imaging apparatus of claim 14, wherein the instructions executable to identify the at least one indicator based upon a differentiable presentation are executable to differentiate the presentation of the at least one indicator from other content in an image page.

16. The imaging apparatus of claim 11, wherein the instructions executable to identify the at least one indicator are executable using a metadata engine to identify the at least one indicator by analysis of content of the image saved by the OCR functionality.

17. The imaging apparatus of claim 16, wherein the apparatus includes instructions executable to use at least one coordinate derived from analysis of the at least one indicator by the metadata engine to define at least one location of content in the saved image.

18. The imaging apparatus of claim 17, wherein the apparatus includes instructions executable to provide at least one tag in the saved image to further define the at least one location of content serving as metadata.

19. The imaging apparatus of claim 16, wherein the apparatus includes instructions executable to identify and use at least one indicator having a differentiable alphanumeric name in a name/value pair with at least one coordinate defining content in at least one location, wherein at least a portion of a name in the name/value pair is contained in content at least one location.

20. The imaging apparatus of claim 19, wherein the instructions executable by the metadata engine to identify the at least one indicator are executable to identify the indicator using at least two different delimiter characters that differentiate at least two of:
the differentiable alphanumeric name;
the at least one coordinate defining at least one location of content; and
a termination of the indicator.
